(19) United States
(12) Patent Application Publication
(10) Pub. No.: US 2008/0182167 A1
(43) Pub. Date: Jul. 31, 2008

(54) Separator for installation in batteries and a battery

(75) Inventor: Peter Kritzer, Forst (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: Carl Freudenberg KG, Weinheim (DE)

(21) Appl. No.: 11/953,804

(22) Filed: Dec. 10, 2007

Related U.S. Application Data
(63) Continuation of application No. 11/743,948, filed on May 3, 2007.

(30) Foreign Application Priority Data
May 5, 2006 (DE) 102006021273.8-45

(51) Int. Cl. H01M 2/16

(52) U.S. Cl. 429/129

(57) ABSTRACT

A separator for installation in batteries, comprising at least one first layer and at least one second layer, wherein the layers are configured as nonwovens, is characterized with respect to the object of creating a battery, which following easy production guarantees a long service life and high power, in that the first layer comprises fibers with a mean diameter that is greater than the mean diameter of the fibers of the second layer.

### TECHNICAL FIELD

The invention relates to a separator for installation in batteries, comprising at least one first layer and at least one second layer, wherein the layers are non-woven fabrics. The invention furthermore relates to a battery comprising a separator.

### STATE OF THE ART

In chargeable battery systems that use aqueous electrolytes, the electrolyte is involved in the chemical reaction occurring during charging or discharging of the battery. In known battery systems, a sufficiently large electrolyte reservoir must be present, which is typically provided by a nonwoven separator. For this purpose, a sufficiently large volume of the nonwoven separator is required. As a result, a decreased thickness of the separator can be implemented only to a limited extent.

In lithium batteries, no aqueous electrolyte is used due to their high electrochemical potential because the electrolyte would decompose. In this type of battery, organic fluids that are stable to oxidation, such as propylene carbonate are used, which are not involved in the chemical reactions during charging and/or discharging. They only assume the function of ion transport, so that in these battery systems the separator can be very thin. The thickness of the separator is merely limited by the mechanical stability, particularly the penetration resistance.

High power batteries are used preferably in power tools. Batteries of this type require separators with increased porosity. The increased porosity of the separator improves the capacity of the battery and thus of the tool in which the battery is used.

The separators known from the state of the art exhibit considerable disadvantages, either with respect to their porosity or with respect to their mechanical stability.

### DESCRIPTION OF THE INVENTION

It is therefore the object of the invention to create a battery, which is easy to produce, is very powerful and guarantees a long service life.

The present invention achieves the above object by the characteristics of claim 1. According to this claim, a separator is characterized in that the first layer comprises fibers, the mean diameter of which is greater than the mean diameter of the fibers of the second layer.

According to the invention, it was found in a first step that the separators known from the state of the art often have insufficient stability. In a second step, it was found that the stability of a separator can be increased in that at least one layer acts as a carrier layer. According to the invention, the carrier layer comprises fibers with a larger diameter than those of a second layer. According to the invention, the second layer has a fiber structure, which can guarantee extremely high porosity with a small pore size. As a result, a battery can be implemented, which has a stable separator, thus allowing easy production of the battery. Due to the stability of the separator, it is not only possible to achieve easy production of the battery, but also a long service life. Finally, a high level of porosity can be produced with the separator according to the invention, so that a battery with high power capability can be achieved.

Consequently, the object mentioned above has been achieved.

The first layer could comprise fibers with a mean diameter measuring more than 2 μm. The second layer could comprise fibers with a mean diameter measuring less than 800 nm. This concrete embodiment allows the configuration of a sufficiently stable carrier layer, which stabilizes the second layer. Consequently, the second layer does not have to meet very high mechanical requirements and its porosity and fiber structure can be adjusted independently from the first layer. It is known that excessive pore sizes may result in the failure of a battery. Pores that are too large may allow the development of conductive branched projections, referred to as dendrites, and lead to short circuits. The use of nano-fibers enables the formation of a nonwoven with very high porosity, while forming a very small pore diameter, so that branchings can be effectively avoided.

The separator could have a three-layer structure, wherein two first layers enclose the second layer between them. This concrete embodiment allows a particularly stable structure of a separator since the layer comprising the nano-fibers is fixed sandwich-like between two stable carrier layers. This concrete embodiment achieves a particularly high penetration stability of the separator.

The separator could have a three-layer structure, wherein two second layers enclose a first layer between them. A separator having this concrete configuration has an extremely high porosity with sufficient stability. The second layers enclose the first layer, which acts as a stabilizing carrier layer, between each other in a sandwich-like manner.

In the above embodiments, it is conceivable that the layers are glued together. Gluing creates a cost-efficient bond.

Furthermore, it is conceivable that the layers are connected to each other by lamination. Lamination enables a continuous manufacturing process.

Furthermore, it is conceivable that the layers are connected to each other by a chemical reaction, such as cross-linking. In this way, a particularly stable and nearly inseparable bond of the layers is achieved.

Furthermore, it is conceivable to weld the layers together, for example by means of electron beams, laser or ultrasound. This type of bond can selectively be carried out either across the entire surface or only in certain points. Depending on whether the layers are connected to each other across the entire surface or only in certain points, the elasticity and flexural strength of the layer composite can be adjusted.

Finally, it is also conceivable to connect the layers to each other by mechanical methods, such as hydroentangling. Hydroentangling enables endless fibers or staple fibers to be interlaced without the use of additional binding agents. In this way, unmixed production of a separator can be achieved, which does not pose a disposal problem. Adhesives or other binding agents that could damage a battery are effectively foregone.

At least one layer could have a layered design. Under these circumstances, it is conceivable that every first layer or every second layer is configured as a layer composite. It is conceivable that each layer comprises fibers with different chemical compositions. Furthermore, it is conceivable that both a first layer and a second layer have a progressive structure. A progressive structure is the formation of a gradient of the fiber diameter in any direction. This structure makes it possible for dirt particles to be absorbed by a layer having coarser porosity in order to protect layers with finer porosity from damage. The addition of coarser layers over time creates a configuration in which layers with coarser porosity increasingly receive smaller pores and can thus bring about a filtration of finer particles.

At least one layer could comprise fibers made of a polymer with a melting point of at least 160° C. From the state of the art, separators are known, which start to melt at temperatures greater than 120° C. At temperatures even greater than this, the entire separator may melt, resulting in what is referred to as a “melt-down effect”. This effect creates a critical state of the battery since the separator materials exhibit considerable thermal shrinkage already at temperatures below this melting point. This may result in the exposure of electrodes with varying charges in a battery. As soon as the electrodes have been exposed, safe operation of the battery is no longer guaranteed.

The first layer could comprise polyester fibers. Polyester is characterized by increased temperature resistance. Following a heating period of 30 minutes at a temperature of 200° C., a nonwoven fabric made of polyester exhibits thermal shrinkage of less than 2%.

The second layer could comprise polyolefin fibers. The use of polyolefin enables defined wear and tear of the pores as the temperature increases. Provided that a polyester layer is combined with a polyolefin layer, the temperature resistance and thus the mechanical stability of the separator is guaranteed, wherein at the same time defined wear and tear of the pores can be achieved. In this respect, a shut-down effect can be defined. The shut-down effect increases the safety of a battery, so that overcharging or a short circuit due to the melting of a special polyolefin material can be counteracted.

Under these circumstances, the second layer, in concrete terms, could comprise fibers made of polyethylene.

The separator could have a basis weight of 5-35 g/m². The selection of the basis weight from this range ensures that the separators have sufficient stability to allow machine processing. In terms of stability, particularly the range from 5 to 20 g/m² has proved to be suitable for processing.

The separator could be characterized by a thickness of 10-35 μm. The selection of the separator thickness from this range ensures that the separator can provide a sufficiently large volume for receiving an electrolyte and furthermore meets the mechanical load requirements. With respect to the absorption capacity, while maintaining minimum thickness, a range of 10 to 25 g/m² has proven to be particularly advantageous.

The separator could have a porosity level of 35-80%. This concrete embodiment allows the use of the separator in high power batteries. With respect to the capacity of a battery, a range of 45 to 80% has proven to be particularly advantageous. From the state of the art, membranes are known, which are stretched directly after extrusion. The porosity of such membranes is typically clearly below the range claimed here.

The separator could have a maximum pore size of 4 μm. The selection of the pore size from the this range ensures that no branchings of the separator occur. The branchings are dendrite structures, which form and result in short circuits. By selecting the maximum pore size from the range mentioned above, the formation of branchings is effectively prevented. A particularly low rate of branchings is achieved when the pore size (pore diameter) does not exceed 2 μm.

The separator could have a maximum tensile force in the longitudinal direction of at least 8N/(5 cm). This concrete embodiment ensures processing without difficulty. Furthermore, this maximum tensile force guarantees that the separator material can be wound on machines. A separator material having the maximum tensile force mentioned above furthermore has high penetration strength.

Following 30 minutes of heating to 140° C., the separator could exhibit thermal shrinkage in the transverse direction of than 5%. Such a separator can be used in a battery even at higher temperatures and/or following extended operation. The use of the separator mentioned above ensures that the electrodes are not exposed with relative certainty. Consequently, the safety of the battery operation is guaranteed even following extended operation and at elevated temperatures.

The object mentioned at the beginning is furthermore achieved by a battery comprising a separator of the type described here.

In order to avoid repetition, reference is made to the explanations provided for the separator with respect to inventive step.

Various possibilities are available for advantageously configuring and further developing the teaching of the present invention. In this respect, reference is made on one hand to the claims subordinated to the equivalent claims and on the other hand to the preferred embodiments of the invention, which will be explained in more detail hereinafter with reference to the table. Generally preferred embodiments and further developments of the teaching are also explained in conjunction with the explanation of the preferred embodiments of the invention with reference to the table.

### BRIEF DESCRIPTION OF THE TABLE

Table 1 shows concrete exemplary embodiments of double-layer separators.

### EXECUTION OF THE INVENTION

Table 1 illustrates materials C1 to C19. These materials comprise two layers A and B.

For layer A, namely the first layer, the following nonwovens were used:
A1: A wetlaid, thermally bonded polyester nonwoven. This nonwoven had a mean fiber diameter of 3 to 4 μm, a basis weight of 8 g/m² and a thickness of 13 μm.
A2: A wetlaid, thermally bonded polyolein nonwoven. This nonwoven had a mean fiber diameter of 3 to 4 μm, a basis weight of 13 g/m² and a thickness of 24 μm.
A3: A wetlaid nonwoven chemically bonded with acrylate binder, which nonwoven was made of polyacrylonitrile fibers having a basis weight of 12 g/m² and a thickness o 24 μm.
A4: A thermally strengthened polyester spun-bond nonwoven. It had fibers with a mean fiber diameter of approximately 9 μm. It had a basis weight of 14 g/m² and a thickness of 26 μm.
A5: A polypropylene melt-blown nonwoven having a basis weight of 13 g/m² and a thickness of 26 μm.
A6: A thermally strengthened polyester dry laid nonwoven. It had fibers with a mean fiber diameter of approximately 12 μm. It had a basis weight of 17 g/m² and a thickness of 26 μm.

For layer B, which acted as the second layer, the following materials were used:
B1: On the first layer, polycarbonate fibers were applied that were electrospun from methylene chloride. The fibers had a mean diameter of less than 800 μm. The second layer had a basis weight of 2 to 10 g/m².
B2: From N-methyl-pyrrolidone, polysulfone fibers as well as polyether sulfone fibers were electrospun onto a first layer. The fibers had a mean diameter of less than 800 μm. The second layer had a basis weight of 5 g/m².
B3: On the first layer, polyethylene fibers were applied, which were electrospun from chloroethylene. These fibers had a mean diameter of less than 800 μm. The second layer had a basis weight of 3 to 5 g/m².
B4: From hexafluoroisopropanol, fibers were electrospun from polyethylene terephthalate and placed on the first layer. The fibers had a diameter of less than 800 μm. The second layer had a basis weight of 3 g/m².
B5: From N,N-dimethylacetamide, polyvinyledene fluoride fibers were electrospun and placed on the first layer. The fibers had a mean diameter of less than 800 μm. The second layer had a basis weight of 3 to 5 g/m².
B6: From perchlorethylene, polypropylene fibers were electrospun and placed on a first layer. The fibers had a mean diameter of less than 800 μm. The second layer had a basis weight of 3 to 5 g/m².
B7: From perchlorethylene, polystyrene fibers were electrospun and placed on a first layer. The fibers had a mean diameter of less than 800 μm. The second layer had a basis weight of 3 to 5 g/m².
B8: Polyacryinitrile fibers were electrospun from dimethyl formamide. The fibers had a mean diameter of less than 800 μm. The second layer had a basis weight of 3 to 5 g/m².
B9: Polyetherimide fibers were electrospun from dimethylformamide. The fibers had a mean diameter of less than 800 μm. The second layer had a basis weight of 3 to 5 g/m².
B10: From a melt, polypropylene and polyester fibers of the type “island in the sea” were spun. The fibers had a mean diameter of less than 800 μm. The second layer had a basis weight of 3 g/m².
B11: In a melt-blown process, polyvinylidene fluoride fibers were spun. These fibers had a mean diameter of 600 μm. The second layer had a basis weight of 5 g/m².

Table 1 shows that the materials C1 to C19 are configured as composites comprising two layers. Material C5 is made of a layer composite of the layers A1 and B2, wherein the layer A1 acts as the first layer and layer B2 as the second layer. Layer A1 acts as the carrier layer and stabilizes the layer composite.

Column 3 of table 1 shows the total weight of the layer composite in g/m². Column 3 lists in parenthesis, which portion of the total weight is attributed to the first layer or the second layer. Column 4 of the table indicates the thickness of the layer composite. Column 5 outlines the porosity of the layer composite and column 6 the maximum pore size. Column 7 lists the maximum tensile force in the longitudinal direction in the unit of measure N/(5 cm). And column 8 provides information about the thermal shrinkage in the transverse direction, listed in %. The level of thermal shrinkage was determined by heating a sample for 30 minutes to 180° C.

With respect to further advantageous embodiments and further developments of the teaching according to the invention, reference is made on the one hand to the general part of the description and on the other hand to the attached claims.

Finally, it shall be noted in particular that the above arbitrarily selected exemplary embodiments only serve the explanation of the inventive teaching, however they do not limit it to these exemplary embodiments.

TABLE 1

| | | Total | | | Max. | | Thermal |
|---|---|---|---|---|---|---|---|
| | | weight | Thickness | Porosity | Pore Size | HZK Iä | Shrinkage |
| Material | Layers | (g/m²) | (μm) | (%) | μm | (N/5 cm) | crosswise* (%) |
| C1 | A1 + B1 | 10 (8 + 2) | 17 | 60 | 3.2 | 14 | <2 at 180° C. |
| C2 | A1 + B1 | 12 (8 + 4) | 21 | 57 | 1.8 | 14 | <2 at 180° C. |
| C3 | A1 + B1 | 14 (8 + 6) | 25 | 57 | 1.2 | 14 | <2 at 180° C. |
| C4 | A1 + B1 | 18 (8 + 10) | 33 | 58 | 1.0 | 15 | <2 at 180° C. |
| C5 | A1 + B2 | 13 (8 + 5) | 21 | 53 | 1.5 | 14 | <2 at 180° C. |
| C6 | A1 + B3 | 13 (8 + 5) | 22 | 50 | 1.7 | 14 | <2 at 180° C. |
| C7 | A1 + B4 | 13 (8 + 5) | 21 | 56 | 1.6 | 14 | <2 at 180° C. |
| C8 | A1 + B5 | 13 (8 + 5) | 22 | 64 | 1.5 | 14 | <2 at 180° C. |
| C9 | A1 + B6 | 13 (8 + 5) | 23 | 53 | 1.8 | 14 | <2 at 180° C. |
| C10 | A1 + B7 | 13 (8 + 5) | 22 | 53 | 1.5 | 14 | <2 at 180° C. |
| C11 | A1 + B8 | 13 (8 + 5) | 22 | 58 | 1.5 | 14 | <2 at 180° C. |
| C12 | A1 + B9 | 13 (8 + 5) | 21 | 54 | 1.4 | 14 | <2 at 180° C. |
| C13 | A1 + B10 | 13 (8 + 5) | 21 | 53 | 1.4 | 14 | <2 at 180° C. |
| C14 | A2 + B2 | 18 (13 + 5) | 27 | 50 | 1.6 | 14 | <2 at 180° C. |
| C15 | A3 + B2 | 17 (12 + 5) | 32 | 56 | 1.6 | 14 | <2 at 180° C. |
| C16 | A4 + B2 | 19 (14 + 5) | 33 | 57 | 1.7 | 14 | <2 at 180° C. |
| C17 | A5 + B2 | 21 (16 + 5) | 32 | 42 | 1.8 | 14 | 10 at 180° C.** |
| C18 | A6 + B2 | 22 (17 + 5) | 32 | 49 | 2.9 | 14 | <2 at 180° C. |
| C19 | A1 + B11 | 13 (8 + 5) | 28 | 69 | 3.6 | 14 | <2 at 180° C. |

1. A separator for installation in batteries, comprising at least one first layer and at least one second layer, the layers being configured as nonwovens, characterized in that the first layer comprises fibers, the mean diameter of which is greater than the mean diameter of the fibers of the second layer.

2. The separator according to claim 1, characterized in that the first layer comprises fibers with a mean diameter that is greater than 2 μm and that the second layer comprises fibers with a mean diameter of less than 800 nm.

3. The separator according to claim 1, characterized by a three-layer structure, the two first layers enclosing a second layer between them.

4. The separator according to claim 1, characterized by a three-layer structure, the two second layers enclosing a first layer between them.

5. A separator according to claim 1, characterized in that at least one layer has a layered design.

6. A separator according to claim 1, characterized in that at least one layer comprises fibers made of a polymer with a minimum melting point of 160° C.

7. A separator according to claim 1, characterized by a basis weight of 5 to 35 g/m², particularly preferred 5 to 20 g/m².

8. A separator according to claim 1, characterized by a thickness ranging from 10 to 35 μm, particularly preferred from 10 to 25 μm.

9. A separator according to claim 1, characterized by a porosity of 35 to 80%, particularly preferred 45 to 80%.

10. A separator according to claim 1, characterized by a maximum pore size of 4 μm, particularly preferred 2 μm.

11. A separator according to claim 1, characterized by a maximum tensile force in the longitudinal direction of at least 8 N/(5 cm).

12. A separator according to claim 1, characterized by thermal shrinkage in the transverse direction, which at 30 minutes of heating at 140° C. is less than 5%.

13. A battery, comprising a separator according to claim 1.
